(19) United States
(12) Patent Application Publication
(10) Pub. No.: US 2005/0127179 A1
(43) Pub. Date: Jun. 16, 2005

(54) Voting device

(76) Inventor: William Spence Rouverol, Berkeley, CA (US)

Correspondence Address: William S. Rouverol;% VoteSure, 1735 Martin Luther King Way, Berkeley, CA, 94709, US

(21) Appl. No.: 10/733,032

(22) Filed: Dec. 11, 2003

(51) Int. Cl. G06F 17/60

(52) U.S. Cl. 235/386

(57) ABSTRACT

In any election where the margin of victory is smaller than the margin of error of the voting equipment, chaos ensues, as it did in the Florida election of the year 2000. To avoid a repetition of that debacle the applicant herewith submits a disclosure of an improved voting device. For such an improvement to have the greatest impact, it is necessary to start with the voting device that already has the lowest error rate. That is the original “Votomatic,” which has an error rate of 1.2%. The specification of the accompanying patent application will explain in detail how the two shortcomings of the Votomatic are eliminated in the new device, which is called the “VoteSure.” The proposed changes in the Votomatic are as follows: (1) the punch system of prescoring the ballot card in the Votomatic is totally replaced by a “shear-card” system that completely eliminates hanging and dimpled chads, and (2) the feedback effectiveness of the backlighting disclosed by applicant in a prior patent application is enhanced more than six fold.

### BACKGROUND OF THE INVENTION

1. Field of the Invention

This invention discloses a new form of voting device that undertakes to eliminate the shortcomings of the Votomatic and other punch-card voting devices. The elimination requires a departure from the punch-card system, by what may best be called a “shear-card” system.

2. Prior Art

Disclosures known to applicant and considered by him to be directly or indirectly related to the present invention are as follows:
Reference 1: Rouverol, W. S., “Voting Device with Enhanced Feedback,” U.S. patent application Ser. No. 09/895,190, July 2001.
Reference 2: Harris, J. P., “Data Registration Device,” U.S. Pat. No. 3,201,038, August 1985.
Reference 3: Harris, J. P., “Data Registration Device,” U.S. Pat. No. 3,240,409, March 1966.
Reference 4: Laframboise, G. R. et al., “Card Punching Device,” U.S. Pat. No. 3,007,620, November 1961.
Reference 5: Caputo, M., “Democrats to Investigate Voting Machines,” The Palm Beach Post, Nov. 29, 2000.
Reference 6: Rapp et al., “Non-Scored Ballot Card,” U.S. Pat. No. 5,362,104, November 1994, “Punch Type Vote Recording Device,” U.S. Pat. No. 5,260,530, Nov. 19, 1993.
Reference 7: Stevens, R. J. et al., “Data Registering Apparatus,” U.S. Pat. No. 4,488,034, December 1984.
Reference 8: Metzer, M. “Democracy Held Hostage,” Exhibit A, p. 231, publ. 2001 by Miami Herald.

### SUMMARY OF THE INVENTION

The objective of the invention is to disclose a voting device that eliminates the two shortcomings that are inherent in nearly all punch-card voting devices. The shortcomings are somewhat alleviated in the Votomatic, which is why it is able to achieve a 1.2% error rate that makes it the best available voting device today, and applicant believes that the improvements described in the following specifications may afford an error rate as low as 0.2% or 0.3%. The two shortcomings referred to and the proposed corrections are as follows:
(1) The punch-card system was invented in 1961 and patented by IBM under the name “Portapunch” in that year (Reference 4). One of the shortcomings of the Portapunch, which was to produce what is now known as “hanging chads,” was a concern of the inventors and was discussed in the patent specification.

### Corrective

Many designers have worked on the problem of the hanging chads for the past 42 years—without success. Applicant's solution is to abandon the punch-card system, and to replace it with a new system that makes holes in the ballot card by shearing instead of punching to produce what is called a “shear card.” The “shear-card” never produces a hanging chad.

(2) The second shortcoming in the punch-card system is the limitation of feedback, so that the voter does not know for sure whether his punch has produced a countable vote, or simply a “dimpled” chad. In the Florida election of 2000, there were six times as many dimpled chads that were rejected as votes than there were hanging chads, so this was an even more serious problem. For the Votomatic there seems little doubt that nearly all of the 1.2% of undervotes were dimpled chads. There are two causes for dimple chads: one is the long punching stroke required by the rubber die in all punch-card systems, and the other is the limitation of feedback that keeps the voter from being informed of his inadequate punch.

### Corrective

In July, 2001, applicant filed a patent application (Reference 1), called “Voting Device With Enhanced Feedback.” The voting device disclosed in that application had much greater feedback than the Votomatic or any other punch-card system as a result of the introduction of an electric light behind the ballot, so that a light beam was directed upward through any clean punch out to advise the voter of any error made in the punching effort. The problem with the Reference 1 disclosure, however, was that the light beam minimum cross-sectional area was reduced to approximately 0.002 in.² by the small holes in the stylus guide sheet. In applicant's redesign the cutter guide sheet holes are increased in area by 6.25 times by making them 0.125 in. in diameter instead of 0.050 in. (1.27 mm). This multiplication of the feedback cross-sectional light-beam area makes it practically impossible for the voter to avoid noticing that a voting error has occurred.

### BRIEF DESCRIPTION OF THE DRAWINGS

FIG. 1 is an enlarged fragmentary view of a scored Index-point area on a ballot for a typical punch-card voting device, showing the removal chip therein (Prior art).

FIG. 2 is an enlarged sectional view illustrating one step that may occur in punching a chip from the ballot for a typical punch-card voting device (Prior art).

FIG. 3 is a view of the cutter guide plate and die plate subassembly for the preferred embodiment of the invention.

FIG. 4 is a much-enlarged view of a sectional segment of FIG. 3, showing the shape of the spacers at the long edges of the FIG. 3 subassembly.

FIG. 5 is a much-enlarged view of a sectional segment of FIG. 3, showing the shape of the conical holes in the cutter guide plate and die plate.

FIG. 6 is a much enlarged view of the cutter subassembly, showing the circular arc reverse taper that keeps the cutter from binding up in the cutter guide plate or die plate hole if the cutter is slightly tipped out of perpendicularity with respect to the ballot card during the cutting of a hole in it.

FIG. 7 is a much reduced planar view of a typical non-scored ballot card for the preferred embodiment of the invention.

FIG. 8 is a schematic view of one kind of kinematic linkage that may be introduced to increase the perpendicularity of the cutter with respect to the ballot card.

FIG. 9 is a lateral elevation of one link of the FIG. 8 device showing its X-bracing.

FIG. 10 is a semi-schematic view of the voting device subassembly that indicates the location of the light sources and limit switch on the interior of the voting device.

FIG. 11 is a plan view of a “Harris Ballot Book,” such as shown as subassembly 30 in FIG. 9 of Reference 3.

### DESCRIPTION OF THE PREFERRED EMBODIMENT

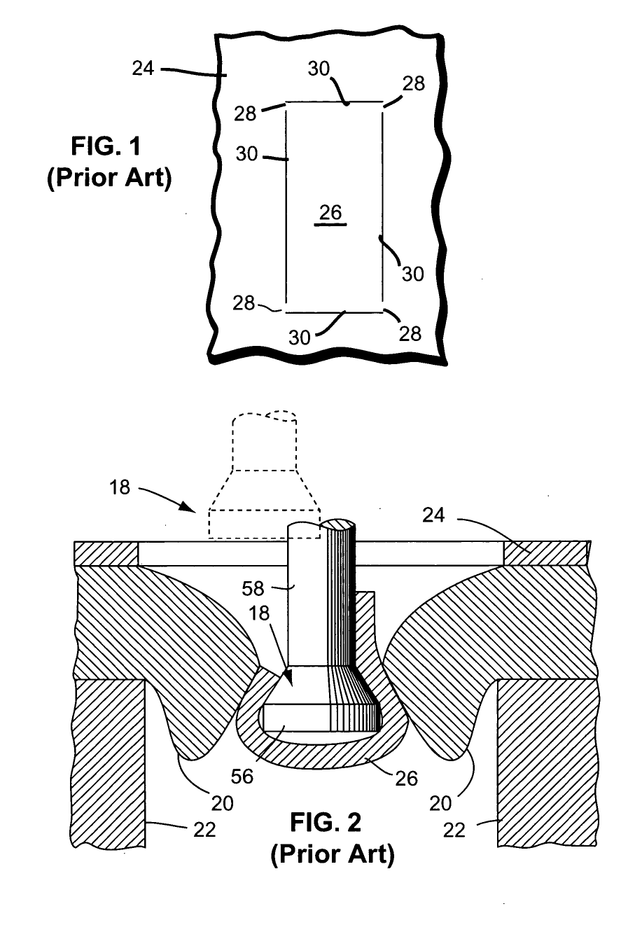

FIGS. 1 and 2 are enlarged copies of Figures from Reference 4 that are helpful for understanding the shortcomings of the Votomatic. As noted previously, its error rate is only 1.2% (Reference 5), which makes it by far the best prior art voting device. But since any error rate greater than zero is undesirable, a major objective of the present invention must be to eliminate the two shortcomings of the Votomatic. The first of these shortcomings is explained in conjunction with FIGS. 1 and 2. FIG. 1 shows the standard punch-card removable chip 26, the rectangular shape and size of which is governed by four scoring lines 30. At each of the four corners is a frangible connection 28 that is not scored and therefore serves to hold the chip 26 in place until it is punched out of the ballot card 24.

FIG. 2 shows an enlarged section of what can happen to the punching operation if the punch 18 strikes the removable chip 26 slightly off center. The frangible connections shown as 28 in FIG. 1 will break sooner at the left end of the chip 26 than at the right (if they break at all), so the chip 26 will ride higher against the neck 58 of the punch 18, remaining pinched between the pliable rubber die strips 20 after the punch 56 is withdrawn, or in more extreme cases, remain attached at its right end to the ballot card 24, to become a “hanging chad.”

A third possibility is that the full punching operation is so deep, to carry the chip down between the rigid ribs 22 that support the rubber die 20, a significant number of voters will fail to punch it deeply enough, so that they produce a “dimpled chad” that is still attached to the ballot card 24 at all four of the chip corners. More often than not, this will not be counted as a valid vote.

The second shortcoming of the Votomatic that needs improvement has to do with feedback. The latest models of the Votomatic all had an electric light mounted adjustably directly over the ballot. This afforded sufficient illumination so the voter could catch about three-fourths of his defective punches and rectify them before turning in his ballot card. In order to increase this three-fourths figure, applicant proposed in Reference 1 moving the light to a position behind the ballot so light would shine through all the voter's punch-outs, to inform the voter regarding the effectiveness of his punching efforts.

The amount of feedback from this arrangement was seriously limited, however, by the fact that the light beam that passed through the hole in the ballot card was greatly diminished by the small size of he holes in the punch guide plate. Because the Votomatic punch probe has a diameter of only 0.050 in. (1.27 mm), the size of the holes provided to guide the probe can only be slightly larger so the amount of light reaching the eye of the voter is too small to be a reliable indicator of an unsatisfactory punch.

The improvements that the applicant proposes for eliminating these two shortcomings on the Votomatic are as follows: (1) to eliminate the inconsistency of the punch-card method of punching a hole in the ballot card, the present invention replaces the punch-card system by the “shear-card” system. The punch-card system, as noted above, was introduced by IBM in 1961 (Reference 4), so it is the newer of the two systems. It is inferior to the old “shear-card” system on all counts except one: aside from the stylus probe it requires no metal parts, so its weight can be a fraction of that of the older system of producing a hole in the card by cutting (shearing).

In the voting machine industry, however, weight is fairly irrelevant, because voting machines are set on a shelf or table, not held in the hand like the IBM “Portapunch” (Reference 4). On all counts, the optimum system for making holes in a ballot card is the old system of shearing, especially in elections where maximum accuracy of ballot perforations is at a premium.

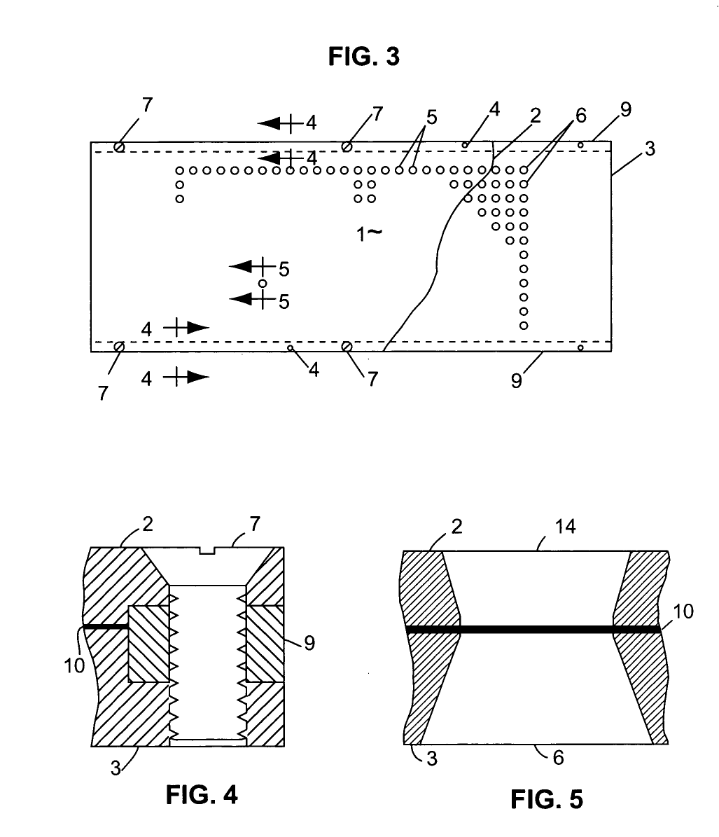

The main features of the IBM punch-card system illustrated in FIGS. 1 and 2 may be compared to those of the shear-card system illustrated in FIGS. 3, 4, and 5. The main differences between the two systems are as follows:

TABLE 1
Distinctions Between Perforation Materials

| | System | Punch-card | Shear-card |
|---|---|---|---|
| 1 | Type of card | Pre-scored | Non-scored |
| 2 | Determiner of size | Size and shape of | Size and shape of |
| | and shape of | pre-scored area | cutter |
| | perforation | | |
| 3 | Performance tool | Slender stylus | Hole cutter |
| | | probe | |
| 4 | Separation method | Pushing down of | Shear of |
| | | pre-scored chad | perforation |
| | | | circumference |
| 5 | Length of tool stroke | Long - ½″ | Short - 1/16″ |
| | | (12.7 mm) | (1.6 mm) |
| 6 | Size of guide holes | Small - 0.050″ | Large - ⅛″ |
| | | (1.23 mm) | (3.175 mm) |
| 7 | Effect of tipped tool | Very adverse | Slightly beneficial |
| 8 | Error form | Makes hanging and | No errors |
| | | dimpled chads | |

This list of eight distinctions between the shear-card system and the punch-card system is also a list of the main favorable characteristics for voting machines. All eight of these favorable features are present only in the shear-card system.

(2) The second shortcoming cited with respect to the Votomatic—limitation of feedback—should be discussed together with the discussion of relative advantages of the shear-card system over the punch-card system. This is because the enhanced feedback made available by backlighting works very well with the shear-card system, but almost not at all with the punch-card system. This is the result of distinction number 6 in Table 1. The larger diameter holes in the cutter guide plate allow 6.25 times as much of the available backlighting to be directed to the eye of the voter, and if the wattage of the backlighting is maximized, say to 20 or 30 watts rather than the fractional wattage used in typical card readers, the combined feedback to the voter can be increased by more than 100 times. Hopefully feedback increases of this magnitude will reduce the number of 12 voters per 1000 being disenfranchised to at most 1 or 2, and at least in some precincts, to zero.

In detail, and referring to the drawings, FIGS. 1 and 2 show prior art and were discussed above. FIG. 3 shows a subassembly 1 in which the cutter guide plate 2 is connected to the die plate 3 with dowels 4 to ensure that the cutter guide plate holes 5 are in perfect alignment with the holes 6 in die plate 3. (In the example shown, cutter guide plate 2 and die plate 3 each have 300 holes in 12 columns of 25 holes).

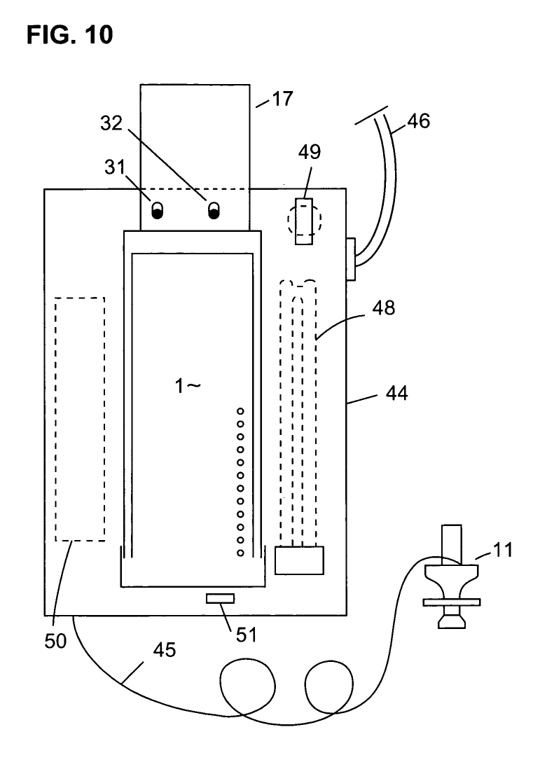

In addition to the two dowel pins 4, there are at least six flat-head screws 7 that hold the guide plate 2 to the die plate 3 and at least two of these screws 7 pass through the die plate 3 to hold the subassembly 2 of FIG. 3 to the housing 44 (FIG. 10). At each of the long sides of subassembly 1 are thin spacer strips 9 that keep the guide plate 2 and die plate 0.005 to 0.006 inches (0.127 to 0.052 mm) apart so the ballot card 10 can slide freely into and out of the subs 1. (The number 10 is actually the card 17 in FIGS. 7 and 10 plus a minute amount of clearance.)

It may be seen in FIG. 5 that the conical hole 5 in the guide plate 2 is exactly aligned with the conical hole 6 in the die plate 3, and both have the same minor diameter, which in the preferred embodiment is 0.125 in. (3.175 mm). To maximize the cutting efficiency, both holes 5 in 6 have a short cylindrical region where they meet. This is the result of the fact that after the guide plate 2 and the die plate 3 are screwed and doweled together, all 300 aligned holes are reamed to produce minor diameters that are identical and exactly aligned.

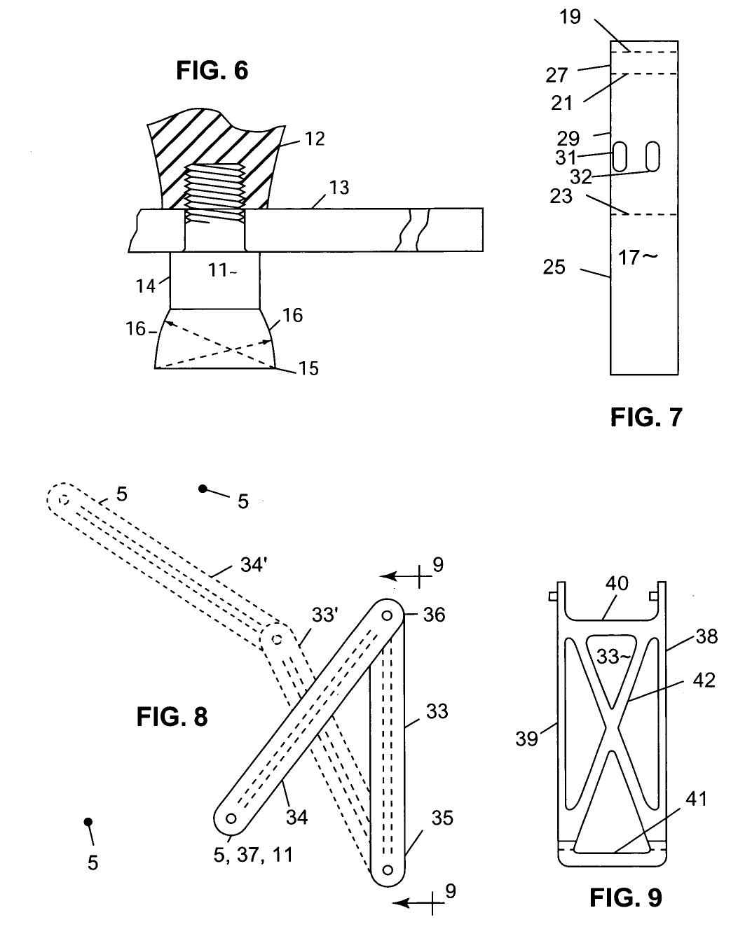

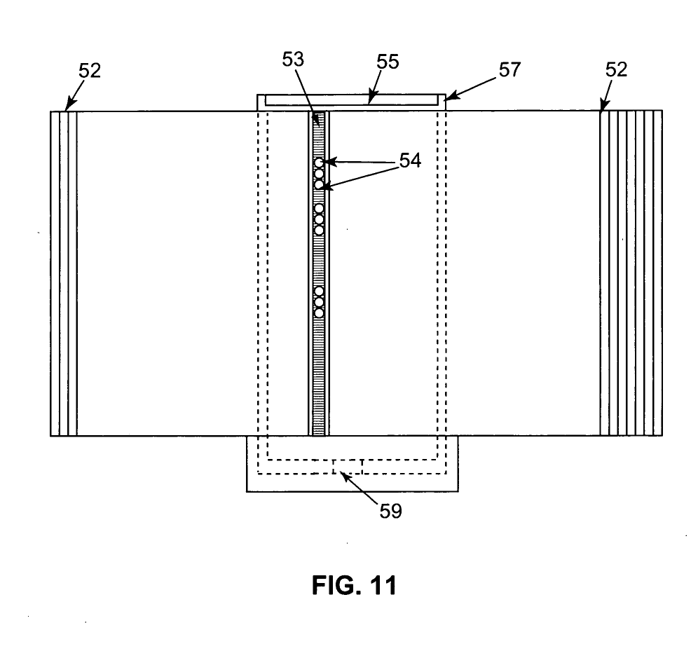

FIG. 6 shows a much enlarged view of the cutter assembly 11, which has three parts, including a plastic or metal handle 12, a transparent plastic “anti-tipping” disk 13, and a cutting element 14 that is threaded into the handle 12 to hold the transparent disk 13 in place. The lower end of the cutting element 14 has a cutter head that has a minor diameter of at most 0.001 in (0.025 mm) less than the diameter of the holes 6 in the die plate 3. A main feature of this cutting head 15 is that its vertical elements have a negative external taper and are circular arcs 16 of the same smooth radius as the diameter of the cutting edge of 15. This feature has the great advantage of ensuring that the hole cut by the cutter will have an almost constant diameter even when the cutter vertical axis is slightly tipped away from perfect perpendicularity to the ballot card 15 (FIG. 11).

It will be seen in FIG. 6 that the cutting edge 15 of cutter 11 is a circle lying in a flat plane. If the plane is parallel to the plane of the ballot card 17 that contains the index area 25 (FIG. 7), the hole cut out by the voter will occur upon downward movement of cutter 11 of only about 0.005″ (0.127 mm), and the resistance to such movement of the cutter 11 would be at a maximum. Even at a maximum, the pressure needed to cut the card is not unacceptable, and can be reduced by making the ballot card of thinner paper if need be. It is the applicant's opinion that since the cutter 11 will nearly always be tipped by more than 2°, there is no need for the flat plane of the cutting edge 15 to be sloped or bent or staggered as suggested in several prior art hole-cutting devices.

FIG. 7 is a greatly reduced plan view of a typical ballot card 17, which has four parts separated by lateral scoring lines but no other significant scoring. The top scoring line 19 separates a thin strip of the card 17 at its top, which is stapled to a packet of other ballot cards. When the precinct official gives the voter a ballot, the separation is made at line 19.

Ballot parts 27, 29, and 25 are still attached to each other when the voter inserts the ballot into the voting device, fitting the extended holes 31, 32 over red pins provided in the insertion slot. After cutting out the vote holes in the index areas in the machine processable portion 25 of the card, the voter reviews his votes, withdraws his ballot from the voting machine, folds it in half at scored line 23 so his votes are not visible, and hands the folded card to the precinct official, who tears off the voter receipt 27 at scored line 21, inserts the folded portion of the card into an open-edged envelope, which is then inserted into the locked ballot box. The write-in portion 29 of the card is removed at the tabulation center. It should be noted that all 300 of the index areas of section 25 of the ballot card are identified by a ⅛″ (3.175 mm) diameter printed circle or dot plus a half circle. The numbers appearing in the first column of index areas go from 1 at the top to 25 at the bottom and so on to 300. These numbers and circles are too small to show.

FIG. 8 discloses an alternative means of constraining the cutter 11 to remain perpendicular to the ballot card 25 while it is cutting apertures in that card 25. The kinematic linkage disclosed in FIG. 8 is more effective than the small (1″ or 25.4 mm diameter) transparent plastic disk 13 shown in FIG. 6, in terms of the amount of tipping of the cutter 11 allowed. The only basis of favoring disk 13 as a feature of the “preferred embodiment” is lower manufacturing cost.

The semi-schematic illustration of a kinematic linkage shown in FIG. 8 is proportioned so that its floating link 34 has a free end spindle 11, 37 that can be readily moved by the voter's hand to all four guide plate corner holes 5. The position of the base link 33 and the floating link 34, which are pinned together at 36, are shown in solid line when cutter 11, which is fixed to the bottom of floating link 34, is over the lower right guide plate hole 5.

When the cutter 11 is moved up to alignment with the upper left guide plate hole 5, the base link 33 moves to the broken line position 33′ and the floating link 34 moves to the broken line position 34′. In all positions of the mechanism its bottom end pivots about a stationary pin 35 that is mounted to remain perfectly perpendicular to the plane of the ballot card index area 25.

FIG. 9 shows an elevation view in the direction of the arrows 9-9 in FIG. 8. In order to retain the greatest degree of parallelism between the opposite side or end elements of link 33, what is called “X-bracing” 42 in automotive chassis engineering is introduced. If elements 40 and 41 are held in opposite hands and twisted in opposite directions, the rectangular elements 38, 39, 40, 41 will tend to be warped out of a flat plane, so that the left end of element 40 and the right end of element 41 will be deflected downwards relative to the plane of the paper, while the other ends of elements 40 and 41 will be deflected upwards. If the oblique ends of the X-bracing, which connect opposite corners of the rectangle 38, 39, 40, 41 were not connected at their centers, there would be substantial space produced between the centers of the X-braces. But since these elements are connected at their centers, they will both act to minimize the warping deformation of the entire structure, and connecting pins 35, 36, 37, will retain a high degree of parallelism for all portions of the mechanism. Both the base link 33 and the floating link 34 should have X-bracing. This ensures that the cutter 11 will always be perpendicular to all holes 5 and 6 of subassembly 1.

FIG. 10 shows a plan view of the base portion of the new voting device and indicates where the main elements of the invention are positioned. The housing 44 is preferably made of translucent colored polycarbonate, so that it glows when the interior light sources (fluorescent lamp 48 and tilted mirror 50) are illuminated. Housing 44 is about 9″ (229 mm) by 12″ (305 mm) by 3″ (76 mm) deep. A rectangular hole is provided at its center to expose the top surface of subassembly 1. Other parts shown (or indicated in broken line) are the ballot card 17; the cutter assembly 11 (enlarged); a bead chain 45; ballast 49; electric power line 36; and a limit switch 51. The limit switch 51 is positioned so that it turns on the power for the light source 48, 50 so when the ballot card 17 is fully inserted and pushed down over locator pins 31, 32. If it is desired to maximize the illumination of the left side of card 17, lamp 48 and tilted mirror 50 may be interchanged. Or if it is desired to increase the service life of the fluorescent lamp 48, it may be left on throughout the entire Election Day.

The invention has, like the Votomatic voting machine, two parts or subassemblies: a base part (FIG. 10) and a removable upper part (FIG. 11), that holds all the portions that precinct officials take off to install the ballot pages 52 and the mask 53 that will correctly register the voter's allowable choices. The ends of the spaced-apart axles 55 on which the ballot pages 52 are mounted are held in a rectangular plastic frame 57 that fits around subassembly 1 (FIG. 10), being held in place by a ledge at the top of the rectangular hole in the housing 44 and a latch at the bottom of housing 44 that is operated to engage a hole 59 at the lower end of the plastic frame 57.

The removable assembly (FIG. 11) is called in this application the “Harris Ballot Book,” in honor of the late Professor Joseph P. Harris, the later inventor of the Votomatic. (See also subassembly 30 in Reference 3.) It is identical to the corresponding portion of the Votomatic in every respect except the color of mask 53, which is yellow in the Votomatic but black in the present invention so as to maximize the contrast with the backlighting. When the Harris Ballot Book is open to its last two pages it has votable items on the left page and an admonition to the voters to leaf through all pages of said book to verify that all votes are correct, complete and not overvoted.

One special feature envisaged for all embodiments of the invention is that the preferred backlighting is dual, whether it is two bulbs or one bulb 48 and a mirror 50 (FIG. 10), so that it can straddle the region where the chads will drop by gravity. (b) To ease the cutting operation, the cutter should be made of a metal that will not gall with either the cutter guide plate 2 or the die plate 5 (FIG. 5).

1. A shear-card voting device having a housing, a die plate with a flat area, a machine-processable record card having a plurality of index-points that are (a) in the region of said card that rests on said flat area and (b) are unscored, a cutter guide plate, a hand-positioned cutter assembly that includes a cutter formed to shear an aperture in said card, and an electric light source mounted below the plane of said flat area in a position to direct upward toward the eye of the user a light beam through each aperture made in said card by said cutter.

2. A shear-card voting device having a housing, a die plate with a flat area, a machine-processable record card having a plurality of index-points that are (a) in the region of said card that rests on said flat area and (b) are unscored, a cutter guide plate, a hand-positioned cutter assembly that includes a cutter formed to shear an aperture of at least 1 mm diameter in said card, and an electric light source mounted below the plane of said flat area in a position to direct upward toward the eye of the user a light beam through each aperture made in said card by said cutter, said beam having a minimum cross-sectional area at least as large as the area of said aperture.

3. A shear-card voting device having a housing, a die plate with a flat area, a machine-processable record card having a plurality of index-points that are (a) in the region of said card that rests on said flat area and (b) are unscored, a cutter guide plate, a hand-positioned cutter assembly that includes a cutter formed to shear an aperture in said card, and an electric light source mounted below the plane of said flat area in a position to direct upward toward the eye of the user a light beam through each aperture made in said card by said cutter, said device also having a mask that prevents the voter from cutting any aperture in said card at any index point that does not represent an allowable choice for the voter, said mask having a dark top surface that enhances the feedback from said beam.

4. A shear-card voting device having a housing, a die plate with a flat area, a machine-processable record card having a plurality of index-points that are (a) in the region of said card that rests on said flat area and (b) are unscored, a cutter plate guide, a hand-positioned cutter assembly that includes a cutter formed to shear an aperture in said card, and an electric light source mounted below the plane of said flat area in a position to direct upward toward the eye of the user a light beam through each aperture made in said card by said cutter, and said device also includes a means to constrain the central axis of said assembly to move about said cutter, said area substantially at right angles thereto.

5. A shear-card voting device according to claims 1, 2, 3, or 4 wherein said cutter is round and has a negative outer diameter taper.

6. A shear-card voting device according to claims 1, 2, 3, or 4 wherein a Harris Ballot Book is mounted above said cutter guide plate.

7. A shear-card voting device according to claims 1, 2, 3, or 4 wherein said die plate and said cutter guide plate are doweled together as a subassembly on opposite sides of a slot containing said record card.

8. A shear-card voting device according to claims 1, 2, 3, or 4 wherein a limit switch is mounted adjacent to the slot containing said record card and is connected in series with said electric light source.

9. A shear-card voting device according to claim 6 wherein said Harris Ballot Book that when open to the last two pages has votable items on the left page and an admonition to the voter to leaf through all the pages of said book to verify that all votes are correct, complete, and not overvoted.

10. A shear-card voting device according to claims 1, 2, 3, or 4 wherein said cutter is a subassembly that includes the reverse taper cutting tip, a transparent disc at least 15 mm in diameter, and a handle.

11. A shear-card voting device according to claims 1, 2, 3, or 4 wherein said housing is made of translucent colored plastic.

12. A shear-card voting device according to claims 1, 2, 3, or 4 wherein said cutter assembly is mounted on a kinematic linkage that constrains it to remaining perpendicular to said flat area at all times.

13. A shear-card voting device according to claims 1, 2, 3, or 4 wherein said cutter is made of a metal that is non-galling with the metal of said cutter guide plate and the metal of said die plate.

14. A shear-card voting device according to claims 1, 2, 3, or 4 wherein said light source has at least two illuminators that straddle the region where cutouts from said record-card fall by gravity, and one of said illuminators is a mirror.

15. A shear-card voting device according to claim 5 wherein said negative taper has a circular profile with a radius equal to the diameter of said cutter tip and a center at the opposite end of said diameter.

16. A shear-card voting device according to claim 13 wherein one of the links of said kinematic linkage has X-bracing.
